(19) United States
(12) Patent Application Publication
(10) Pub. No.: US 2011/0015887 A1
(43) Pub. Date: Jan. 20, 2011

(54) METHOD FOR MANUFACTURING AND TESTING THE FUNCTIONALITY IN MANUFACTURING

(75) Inventors: HERBERT HORST, KORNWESTHEIM (DE); HANS-CHRISTIAN SCHNABEL, FRIOLZHEIM (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, WEISSACH (DE)

(21) Appl. No.: 12/833,176

(22) Filed: Jul. 9, 2010

(30) Foreign Application Priority Data
Jul. 18, 2009 (DE) 10 2009 033 806.3

(51) Int. Cl. G06F 19/00; G01N 37/00

(52) U.S. Cl. 702/82; 702/81; 702/185

(57) ABSTRACT

A method is proposed for manufacturing and testing of complex products, in particular motor vehicles in series production, wherein all the data for the individual manufacturing stations in the manufacturing line is stored in a central computer. In this case, different models are manufactured on the manufacturing line, such that the correspondingly configured data is provided at each manufacturing and test station for this model, after identification of the model. A technical test is carried out in conjunction with the manufacturing installation by monitoring the vehicle functions or else the equipment for their function. An attributive test is carried out by the worker at the manufacturing stations, with all the recorded test data being supplied to the central computer for central evaluation, and with the data being stored on the basis of individual categories in the central computer, such that it is possible to evaluate the manufacturing process with respect to the individual manufacturing steps.

### CROSS-REFERENCE TO RELATED APPLICATION

This application claims the priority, under 35 U.S.C. §119, of German application DE 10 2009 033 806.3, filed Jul. 18, 2009; the prior application is herewith incorporated by reference in its entirety.

### BACKGROUND OF THE INVENTION

### Field of the Invention

The present invention relates to a method for manufacturing and testing the functionality of process sections and manufacturing steps within a manufacturing process.

German patent DE 100 34 606 B4, corresponding to U.S. patent publication No. 20040093100 A1, discloses a method for producing manufacture-related data in series production, in particular for motor vehicles. In the case of this known method, manufacture-related data is recorded in selected manufacturing sections of the series production by a worker, by a data acquisition device having an input device. In this case, a camera is arranged on the data acquisition device, which camera records images of fault points on the manufacturing objects and transmits these recorded images during the manufacturing process to a central facility, where they are then appropriately evaluated.

A method in which each manufacturing object is allocated a data acquisition device is known from German patent DE 198 29 366 C2, corresponding to U.S. Pat. No. 6,615,094. In this case, manufacture-related data is entered in the data acquisition device in at least some of the manufacturing sections of series production. Some of this data is transmitted during the manufacturing process from the respective data acquisition device to a central facility. In this known arrangement, the data is recorded on a manufacture-related basis by a worker by a data acquisition device, with the fault-related data in this case being entered in the data acquisition device via a touch screen.

These known processes and test techniques may be subject to errors because the data is recorded by a person, since the recording process is also subject to subjective conditions and there is a risk of non-standard operation and therefore of a non-standard procedure in the event of fault actions.

### SUMMARY OF THE INVENTION

It is accordingly an object of the invention to provide a method for manufacturing and testing the functionality in manufacturing which overcome the above-mentioned disadvantages of the prior art methods and devices of this general type.

With the foregoing and other objects in view there is provided, in accordance with the invention a method for manufacturing and testing of complex products, including motor vehicles in series production. The method includes storing all data for individual manufacturing stations in a manufacturing line in a central computer and manufacturing different models on the manufacturing line and correspondingly configured data is read at each manufacturing and test station after identification of a model. The manufacturing is tested via a technical test in conjunction with a manufacturing installation such that a unit under test as well as equipment are monitored for function. An attributive test is carried out via a worker at test and manufacturing stations. All recorded test data is supplied to the central computer for central evaluation. The recorded test data is stored on a basis of individual categories in the central computer, such that it is possible to evaluate a manufacturing process with respect to individual manufacturing steps and vehicle modules.

The present method is therefore based on the object of providing a test and completion technique for manufacture, which makes it possible to make available the various test and completion processes of the individual manufacturing processes at the respective manufacturing stations, and to centrally combine and evaluate the results of the test and completion processes.

This results in the advantage that test contents and completion scopes covering all the test stations can be transmitted from one manufacturing station to the next manufacturing station, and various functions can be transferred from a central unit to different test and completion stations.

The coordination of the test and manufacturing processes additionally has the advantage that the contents can be matched to the cycle times of the manufacturing processes. This makes it possible to reduce the cycle times for the contents, with the same quality.

The central coordination of the processes and test routines furthermore makes it possible to organize the test and completion operation autonomously and to implement this immediately on a variant-dependent basis in various test and completion processes by comprehensive configuration options in manufacturing planning.

The provision of a standardized input capability at the individual stations ensures that a standard control and visualization concept can be used, thus minimizing the risk of incorrect actions, thus sensibly assisting the rotation of workers in production.

The manufacturing and test system according to the invention can be used throughout the entire manufacturing process of automobile production. This relates both to technical manufacturing and test processes: inter alia, filling with media, that is to say for example the filling of the braking system, the air-conditioning system, the cooling water or the fuel tank, the documentation of the screw connection processes, for example for wheel, belt, seat and chassis screw connections, the adjustment of the chassis and headlights, underbody protection, the inscription of the chassis number or the coding and the flashing of controllers, and to attributive tests by workers, such as acknowledgements, fault inputs, actioning of test instructions, inhibit messages, etc.

Furthermore, the use of the manufacturing and test system according to the invention makes it possible to coordinate a wide range of different variants of completion processes for the various work steps on an organized basis, and to ensure this on a variant-dependent basis. Preassembly processes, for example wheel manufacture, are also included in this manufacturing process independently of the direct manufacturing process, and can likewise be controlled and appropriately tested on a variant-specific basis.

Other features which are considered as characteristic for the invention are set forth in the appended claims.

Although the invention is illustrated and described herein as embodied in a method for manufacturing and testing the functionality in manufacturing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing information flows in a manufacturing and test system according to the invention;

FIG. 2 is an illustration showing an overview of a configuration and evaluation of the manufacturing and test system;

FIG. 3 is an illustration showing the process procedure at a station in the manufacturing and test system according to the invention;

FIG. 4 is an illustration showing an example of the process procedure at a test station in the manufacturing and test system; and

FIG. 5 is an illustration showing an overview of the definition of the test module scope.

### DETAILED DESCRIPTION OF THE INVENTION

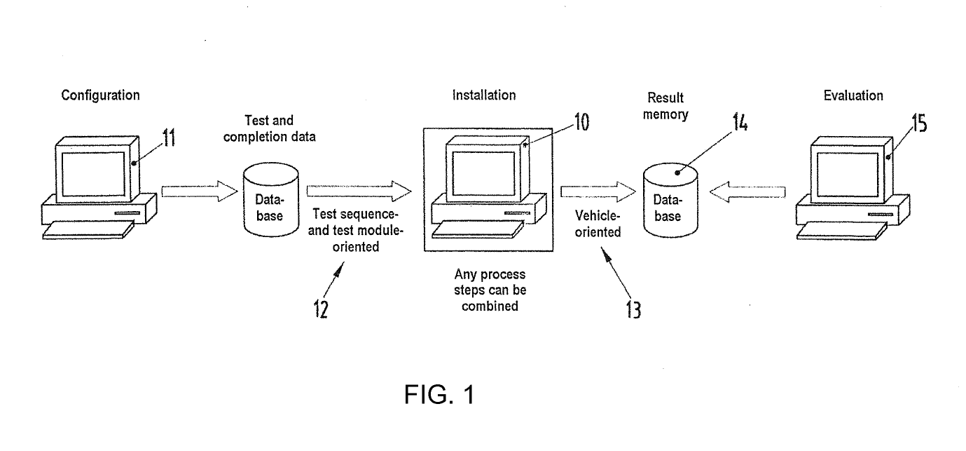

Referring now to the figures of the drawing in detail and first, particularly, to FIG. 1 thereof, there is shown an overview of information flows in a manufacturing and test system according to the invention. The manufacturing installation is illustrated by way of example here, and is provided with the reference symbol 10. As usual for manufacturing lines, the manufacturing installation 10 contains a multiplicity of individual manufacturing sections and process steps. The installation 10 is connected to a central module 11 which makes the data for manufacture available in a database and supplies it via the link 12 to the respective associated manufacturing section. The appropriate test and completion processes for the manufacturing step are therefore likewise provided via the link 12 in the manufacturing installation 10. The individual process steps are monitored on a vehicle-oriented basis, and the results are passed as appropriate via a link 13 to a result memory 14. By way of example, the result memory 14 may be in the form of a database. A downstream evaluation unit 15 accesses the stored data in the result memory 14 as required, in order in this way to carry out specific evaluations relating to the individual process steps.

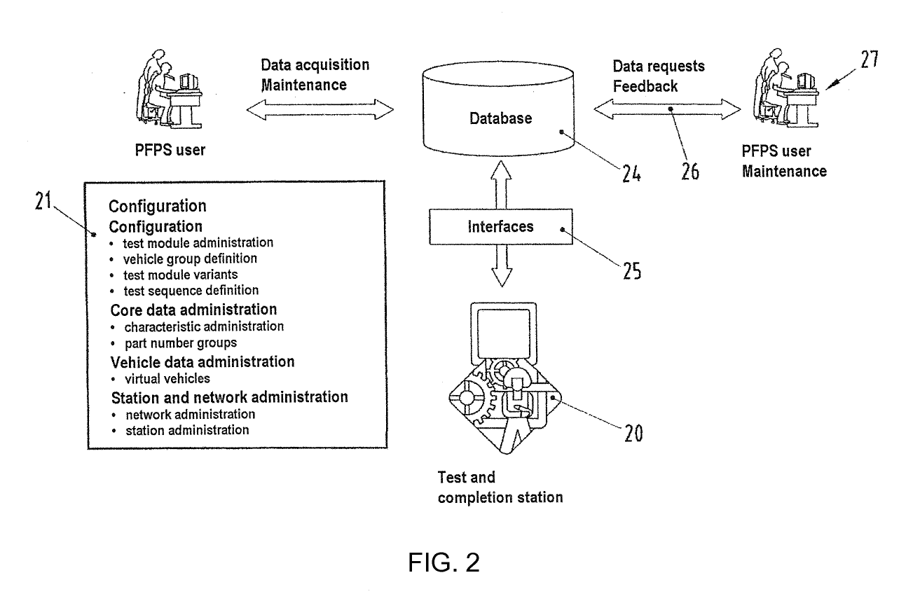

FIG. 2 illustrates the configuration and the evaluation of the manufacturing and test system in more detail. Reference symbol 21 denotes a configuration application by which all the system data can be modified. The data is maintained by the user of the manufacturing and test system. All the attributive technical data can be recorded, with the data items being appropriately linked to one another, via appropriate test module administration, vehicle group definition, the definition of test module variants and test sequence definitions, as well as core data administration, vehicle data administration, in the process step of configuration, in order in this way to provide a uniform system for all manufacturing sections. Furthermore, vehicle data administration is integrated in each case. The configuration process therefore also provides access to the network administration and the station administration of the individual process steps and provides all the data which is required at the individual process stations. The data for the configuration application 21 is maintained by the user in a database 24 of the manufacturing and test system. The database 24 shown in FIG. 2 has the same function as the result memory 14 in FIG. 1. The database 24 passes on the test data as appropriate via various interfaces 25, for the technical and attributive tests of the individual systems, to the respective test and completion station. The test stations are provided with the reference symbol 20 in FIG. 2. The individual test stations 20 therefore have a capability for technical and attributive test and completion which, in conjunction with the manufacturing installation, represents a standard test and completion system for all equipment.

Furthermore, the data for an attributive test by the worker is available at the individual test and completion stations, and is added to here by text and/or image display of the component to be assessed. The fault input can be supported by an image. Parts ordering for incorrectly delivered parts or damaged parts can be generated automatically or manually at these test and completion stations. At the same time, all those components are displayed which belong to the vehicle and must be delivered to or installed at the appropriate workstation. If a fault message from technical or attributive tests occurs at a station such as this, the fault symptoms are displayed and, after repair at the same station or a subsequent station, the causes are displayed via a function unit key. This function unit key additionally includes the information about the nature of the fault, the location of the fault and, for example, additional text for appropriate additional information. This therefore allows comprehensive and standard display of the results of the technical and attributive test and completion. These fault symptoms and fault causes are passed on to the responsible manufacturing planner and to maintenance, via a link 26 for data checking and for feedback to an appropriate information tool 27.

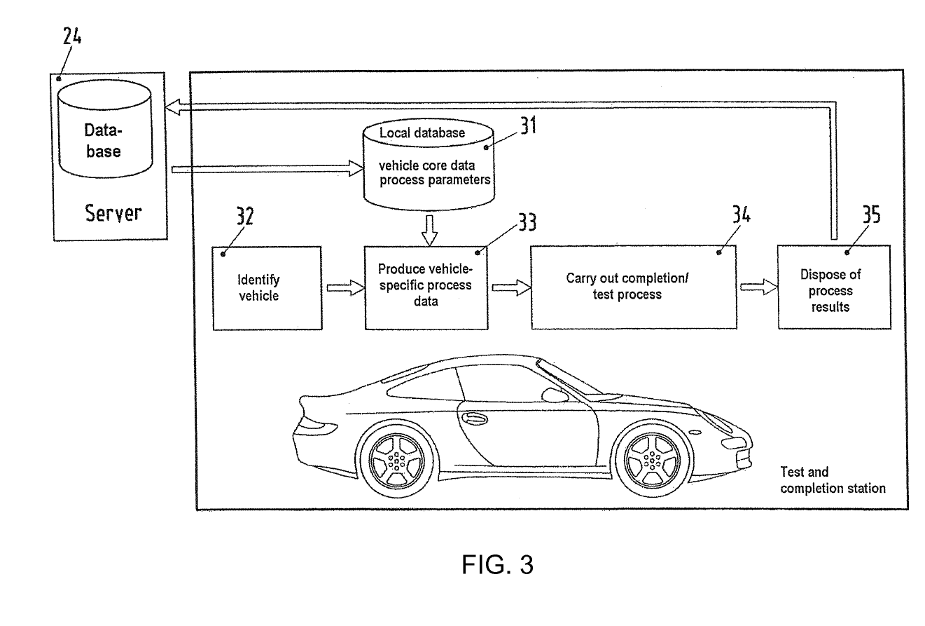

FIG. 3 shows a process procedure at a manufacturing and test station. The vehicle core data and the process parameters for the appropriate manufacturing step and the test are provided by the central server 24. This is illustrated in FIG. 3 with the work step 31. First of all, the vehicle is identified 32 at the manufacturing and test station, in order to appropriately obtain the correct vehicle-specific data and process data 33 associated with that vehicle from the local database 31. In step 34, the manufacturing process and the test are then carried out. The results of the test are combined in step 35 for this manufacturing and test step, and can be transmitted to the server 24.

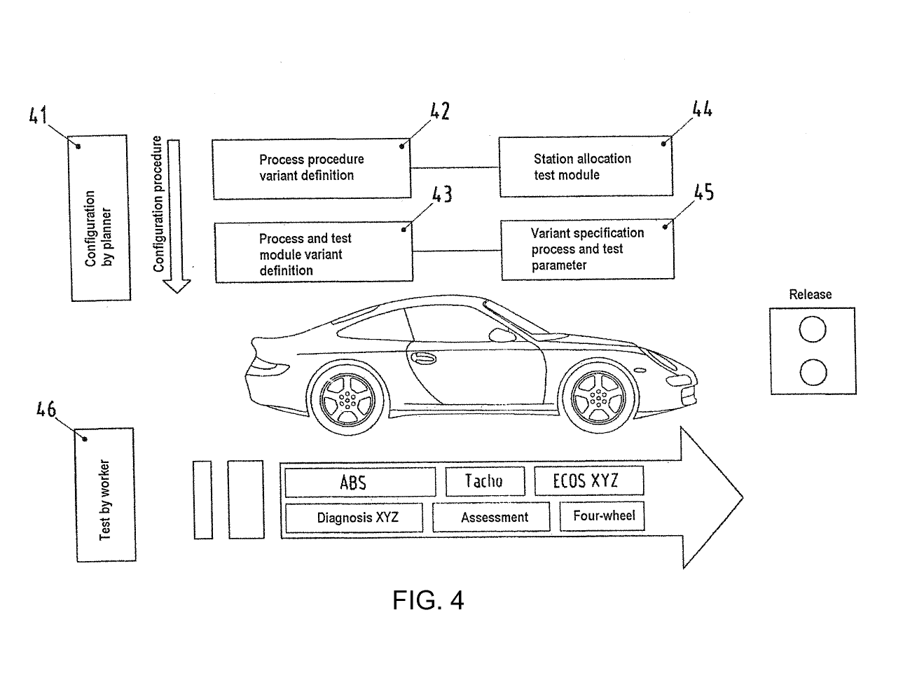

The next figure, FIG. 4, shows by way of example the process procedure at a test and completion station in the manufacturing and test system according to the invention. The configuration process 41 is carried out first of all. Here, the process procedure variants 42 required for this test and completion station, the variant definition of the process and test module 43, a station allocation of the test module 44 and the variant-specific process and test parameters 45 are predetermined and produced. The worker can use all of this information, together with the requirements, to carry out the technical and attributive test and completion of the individual modules on the vehicle. The worker is illustrated symbolically by the reference symbol 46 in FIG. 4. Testing is carried out at this station on the ABS, the Tacho, a test of the controller and diagnosis of the functionality of the controller, as well as a final assessment. If all of the items in the test to be carried out are positive, a release can be given for passing the vehicle onto the next manufacturing test station by appropriate visual information, such as a red or green lamp. The test result can also be passed on to the conveyor system, for automatic control of the vehicles.

The manufacturing and test system according to the invention therefore provides the capability to carry out a technical test in complex manufacturing installations, and to provide a uniform test and completion system across all equipment.

An appropriate display of the component to be assessed is made available for the attributive test, for example processor instructions, inhibit messages, model installation and subjective assessment by the worker, thus allowing acknowledgement and fault input easily on the screen, for example by touch control and possibly by an electronic worker identification number.

The delivery of incorrectly delivered parts, or parts delivered in a faulty condition, can likewise be corrected and entered directly on the monitor. The technical test and the attributive test are recorded via a standard system, and are combined by standard comprehensive configuration and result storage. The fault symptoms and fault causes relating to the technical test and the attributive test are displayed comprehensively by function unit keys.

The system updates itself continuously, since the databases also learn by the vehicle symptoms and the fault causes being entered in real time and continuously, and with the causes for fault symptoms being continuously added to and completed. At the same time, the central administration of fault symptoms and the determination of fault causes allows a fault which has already occurred at an earlier stage in the manufacturing process relating to a different process step to be identified, with action being taken specifically at this manufacturing station, in order to prevent faults.

Furthermore, the central administration of the individual process steps makes it possible to include reworking or appropriate fault correction directly in the series manufacturing process. For example, it is possible to configure fault symptoms such that information is passed to a responsible authority directly after their occurrence, in order to allow the fault to be assessed before the reworking that needs to be carried out.

This overall system of test and completion at the same time provides the capability to display factory information centrally or else to include a station-related cycle time and pause times. In addition, it should also be mentioned that faults which have occurred can also, of course, be evaluated statistically. Central recording makes it possible to store all data with a documentation obligation relating to a vehicle in an archiving file, and to pass this on electronically, and to store it in appropriate files for archiving. The proposed manufacturing and test system according to the invention can be used throughout the entire vehicle assembly process, and can also appropriately combine the individual manufacturing stations over all locations.

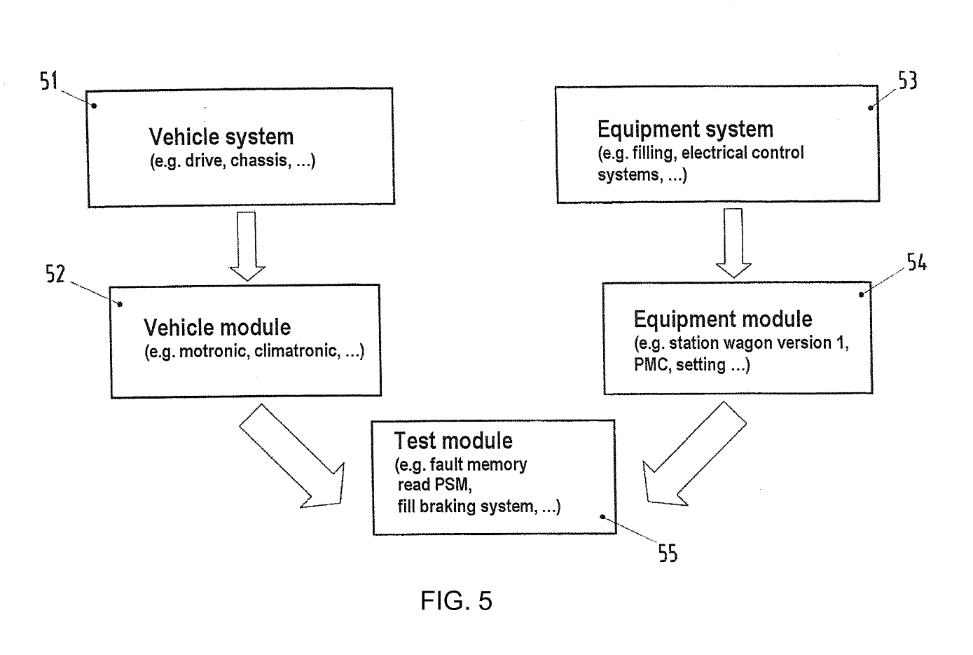

Finally, FIG. 5 shows the definition of the test module scope, as an overview. The manufacturing and test system according to the invention makes it possible to test a vehicle system 51 via an appropriate vehicle module 52 and equipment 53 via an equipment module, and to combine the data in a comprehensive test module 55 which is carried out at a test station.

1. A method for manufacturing and testing of complex products, including motor vehicles in series production, which comprises the steps of:
storing all data for individual manufacturing stations in a manufacturing line in a central computer;
manufacturing different models on the manufacturing line and correspondingly configured data is read at each manufacturing and test station after identification of a model;
testing the manufacturing via a technical test in conjunction with a manufacturing installation such that a unit under test as well as equipment are monitored for function;
carrying out an attributive test via a worker at test and manufacturing stations; and
supplying all recorded test data to the central computer for central evaluation, and the recorded test data being stored on a basis of individual categories in the central computer, such that it is possible to evaluate a manufacturing process with respect to individual manufacturing steps and vehicle modules.

2. The method according to claim 1, wherein the attributive test is assisted by at least one of a text display and an image display of a component to be assessed, wherein fault inputs are entered by an action on a test and manufacturing station.

3. The method according to claim 1, which further comprises recording fault symptoms and fault causes in a comprehensive form in the central computer and are matched to different function units, such that faults which have already been caused at a previous manufacturing station are rectified by appropriate information at this or at a later test and manufacturing station.

4. The method according to claim 3, wherein the fault causes can be directly associated with the manufacturing station and the vehicle modules.

5. The method according to claim 4, which further comprises weighting the faults into different categories and, depending on a category of the fault, either an additional test person is automatically informed that a vehicle must be removed from the manufacturing line in order to rectify the fault, or that a time for reworking is allocated.

6. The method according to claim 3, wherein, in a case of vehicles in which the faults have not all been rectified, the vehicle is not released for delivery.

7. The method according to claim 1, which further comprises producing an early parts order as a result of a test for incorrect or faulty parts.

8. The method according to claim 1, wherein all predetermined technical and attributive test and completion steps must be acknowledged as having been carried out without faults and completely before a vehicle is released.
